(19) United States
(12) Patent Application Publication
(10) Pub. No.: US 2011/0216035 A1
(43) Pub. Date: Sep. 8, 2011

(54) SURFACE CAPACITIVE TOUCH PANEL, DRIVING METHOD THEREOF AND ELECTRONIC APPARATUS USING THE SAME

(75) Inventors: PO-SHENG SHIH, Miao-Li County (TW); HSUAN-LIN PAN, Miao-Li County (TW); PO-YANG CHEN, Miao-Li County (TW); JIA-SHYONG CHENG, Miao-Li County (TW); CHIH-HAN CHAO, Miao-Li County (TW); CHIEN-YUNG CHENG, Miao-Li County (TW)

(73) Assignee: CHIMEI INNOLUX CORPORATION, Miao-Li County (TW)

(21) Appl. No.: 13/039,267

(22) Filed: Mar. 2, 2011

(30) Foreign Application Priority Data
Mar. 3, 2010 (CN) 201010117041.0

(51) Int. Cl. G06F 3/045

(52) U.S. Cl. 345/174

(57) ABSTRACT

A surface capacitive touch panel, a driving method thereof, a display apparatus using the same, and an electronic apparatus using the same are provided. The surface capacitive touch panel includes a substrate, a conductive film, and a plurality of driving sensing electrodes. The conductive film is formed on the substrate. The conductive film has an anisotropy of impedance to define a lower impedance direction and a higher impedance direction. The driving sensing electrodes are disposed on at least one side of the conductive film and the at least one side is substantially perpendicular to the lower impedance direction. The surface capacitive touch panel of the invention has high positioning accuracy. The touch sensing accuracy of the display apparatus and the electronic apparatus using the surface capacitive touch panel is also desirable.

### BACKGROUND OF THE DISCLOSURE

1. Field of the Disclosure

The invention relates to a touch panel, and more particularly, to a surface capacitive touch panel and a driving method thereof.

2. Description of Related Art

To achieve the goals of more convenient usage, more compact design, and more user-friendly features, many information products have changed their input devices from traditional keyboard or mouse to touch apparatus. The touch apparatus can be assembled with various flat panel displays to obtain functions of both displaying images and inputting operation information.

In the present, the capacitive touch panel and the resist touch panel are the most common touch apparatus. Particularly, a user merely skims the surface of the capacitive touch panel to perform the touch operation so that the capacitive touch panel is much popular in the market.

In the capacitive touch panel, a surface capacitive touch panel has the touch sensing function by merely using a single indium-tin oxide (ITO) film so that the structure design is simple and the manufacturing cost is low. However, the positioning accuracy of the surface capacitive touch panel is not satisfactory so as to limit the application thereof. In other words, for having all the advantages of simple structure, low cost, high positioning accuracy, and wide application, the touch apparatus is needed to be improved.

### SUMMARY OF THE DISCLOSURE

The invention provides a surface capacitive touch panel having high positioning accuracy.

The invention provides a touch sensing method applied in a surface capacitive touch panel having high positioning accuracy.

The invention provides an electronic apparatus having touch operation function and having desirable touch sensing accuracy.

The invention directs to a surface capacitive touch panel including a substrate, a conductive film, and a plurality of driving sensing electrodes. The conductive film has an anisotropy of impedance to define a lower impedance direction and a high impedance direction. The driving sensing electrodes are disposed on at least one side of the conductive film and the at least one side is substantially perpendicular to the lower impedance direction.

In an embodiment of the invention, a length of each of the driving sensing electrodes along a direction perpendicular to the lower impedance direction is from 1 mm to 5 mm.

In an embodiment of the invention, a pitch of the driving sensing electrodes is from 3 mm to 5 mm.

In an embodiment of the invention, the conductive film includes a carbon nanotube (CNT) film.

In an embodiment of the invention, the driving sensing electrodes includes a plurality of first driving sensing electrodes and a plurality of second driving sensing electrodes, and the first driving sensing electrodes and the second driving sensing electrodes are respectively located at two opposite sides of the conductive film. For example, a straight line connected from each of the first driving sensing electrodes to any of the second driving sensing electrodes is substantially interlaced with the lower impedance direction. Alternatively, a straight line connected from each of the first driving sensing electrodes to a most adjacent one of the second driving sensing electrodes is substantially parallel to lower impedance direction. Herein, each of the first driving sensing electrodes and the most adjacent one of the second driving sensing electrodes are simultaneously scanned.

In an embodiment of the invention, the surface capacitive touch panel further includes a driving circuit connected to at least one portion of the driving sensing electrodes to sequentially scan the at least a portion of the driving sensing electrodes. Specifically, the driving circuit includes a grounding unit and a scanning unit. The scanned driving sensing electrode is connected to the scanning unit and the un-scanned driving sensing electrode is connected to the grounding unit. In an embodiment, the scanning unit includes a charge circuit, a storage circuit, and a read-out circuit, wherein the charge circuit and the storage circuit are connected in parallel and the read-out circuit is connected to the storage circuit.

The invention further directs to a driving method for driving the above-mentioned surface capacitive touch panel. The driving sensing electrodes are sequentially scanned. The scanned driving sensing electrode receives a signal.

In an embodiment of the invention, the driving method further includes comparing signals received by three adjacent driving sensing electrodes to determine a position of a touch point in a direction perpendicular to the lower impedance direction.

In an embodiment of the invention, the driving method further includes determining a position of a touch point in the lower impedance direction according to the signals of the driving sensing electrodes.

The invention yet further directs to a display apparatus including the abovementioned surface capacitive touch panel and a display panel, wherein the display panel is disposed at a side of the surface capacitive touch panel.

The invention still further provides an electronic apparatus including the abovementioned display apparatus and an outputting unit. The outputting unit is coupled to the display apparatus and provides an input function so that the display apparatus displays an image.

In an embodiment of the invention, the electronic apparatus is a mobile phone, a digital camera, a personal digital assistant, a notebook, a desk-top computer, a television, a display in automobiles, or a portable DVD player.

In view of the above, a film having an anisotropy of impedance is used as a conductive film of a surface capacitive touch panel in the invention. In addition, the arrangement direction of the driving sensing electrodes is perpendicular to the lower impedance direction of the conductive film.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic view of a surface capacitive touch panel according to an embodiment of the invention.

FIG. 2 is a schematic cross-sectional view taking along line A-A′ of the surface capacitive touch panel depicted in FIG. 1.

FIG. 3 schematically illustrates driving waveforms of the switches in the driving circuit during scanning period according to an embodiment of the invention.

FIG. 4 to FIG. 6 schematically illustrate the signals received by the electrodes X3 to X6 in a simulation test.

FIG. 7 illustrates a schematic view of a surface capacitive touch panel according to another embodiment of the invention.

FIG. 8 schematically illustrates the signals received by the electrodes X3 to X6 of the surface capacitive touch panel 400 in a simulation test.

FIG. 9 illustrates a schematic view of a surface capacitive touch panel according to further another embodiment of the invention.

FIG. 10 illustrates a schematic view of an electronic apparatus according to an embodiment of the invention.

### DESCRIPTION OF EMBODIMENTS

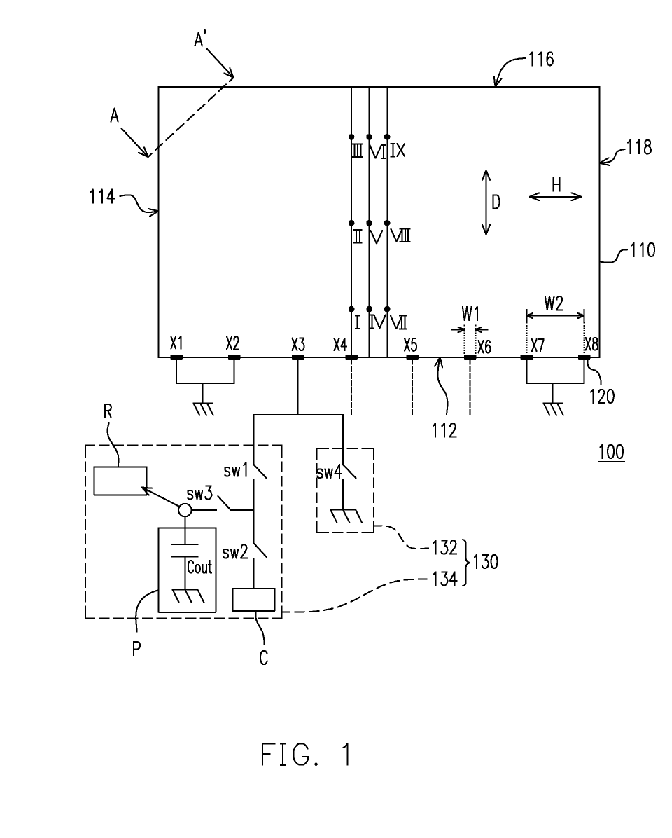

FIG. 1 illustrates a schematic view of a surface capacitive touch panel according to an embodiment of the invention. Referring to FIG. 1, a surface capacitive touch panel 100 includes a conductive film 110, and a plurality of driving sensing electrodes 120. The conductive film 110 has an anisotropy of impedance, i.e. the conductive film 110 has various resistivity in at least two directions so as to define a lower impedance direction D and a higher impedance direction H, wherein the lower impedance direction D can be perpendicular to the higher impedance direction H.

In other words, the conductive film 110 has better conductivity in the lower impedance direction D and has worse conductivity in the higher impedance direction H. In addition, the conductive film 110 according to the present embodiment (for example, a rectangular film) has four sides which are sequentially a side 112, a side 114, a side 116, and a side 118. The side 112 and the side 116 are opposite to each other and parallel to the higher impedance direction H, and the side 114 and the side 118 are opposite to each other and parallel to the lower impedance direction D.

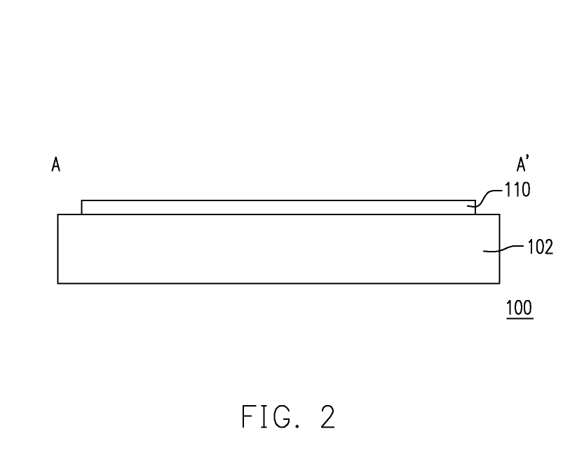

Specifically, FIG. 2 is a schematic cross-sectional view taking along line A-A′ of the surface capacitive touch panel depicted in FIG. 1. Referring to FIG. 2, in the cross-sectional view, the surface capacitive touch panel 100 includes a substrate 102 and the conductive film 110 disposed on the substrate 102. The conductive film 110 includes a carbon nanotube (CNT) film, that is, a material of the conductive film 110 is mainly carbon nanotubes (CNTs). A manufacturing method of forming the conductive film 110 is, for example, forming a CNT layer on a silicon substrate, a quartz substrate, or other suitable substrate through a chemical vapor deposition (CVD) process or other suitable process. Then, a CNT film is drawn out along a tensile direction from a side of the CNT layer so as to form the conductive film 110. Thereafter, the conductive film 110 is disposed on the substrate 102 so that the surface capacitive touch panel 100 is preliminary formed. In the drawing process, the CNTs in the CNT layer are arranged along the tensile direction so that the conductive film 110 can have the anisotropy of impedance.

In addition, referring to FIG. 1 continuously, the plurality of driving sensing electrodes 120 are disposed at the side 112 of the conductive film 110 in the present embodiment. A length W1 of each driving sensing electrode 120 along the higher impedance direction H is from 1 mm to 5 mm and a pitch W2 of two adjacent driving sensing electrodes 120 is from 3 mm to 5 mm. Accordingly, a signal of each driving sensing electrodes 120 inputted to the conductive film 110 or received from the conductive film 110 is mainly transmitted in the lower impedance direction D. The characteristic of the anisotropic signal transmission can be used to determine the touch position in the surface capacitive touch panel 100. In a real product, the sizes and the pitches of the driving sensing electrodes 120 can be modulated based on the required resolution and the application of the products. That is to say, the values mentioned above are merely taken as examples and the invention is not limited thereto.

Specifically, the surface capacitive touch panel 100 further includes a driving circuit 130 connected to at least a portion or all of the driving sensing electrodes 120. It is noted that the driving circuit 130 can be accomplished by various elements and various connection relationship of these elements, and the following embodiment is exemplified as one of the designs of the circuit. However, the following description is not used for limiting the invention. In addition, the so-called “an element” merely means that a specific type of element having the required function or characteristic is disposed in the surface capacitive touch panel 100 in the present embodiment rather than represents that the amount of the element is limited to be one. That is to say, the above-mentioned “a driving circuit 130” can be a single driving circuit 130 which is connected to each of the driving sensing electrode 120 respectively through a suitable process or a multiplexer. Nevertheless, the amount of the driving circuit 130 can be two or more and each of the driving circuits 130 is connected to one or a plurality of the driving sensing electrodes 120. Furthermore, the drawing figure merely shows that one driving sensing electrode 120 is connected to one driving circuit 130 herein for clearly illustrating the manner of the driving circuit 130, but it is understood that a plurality of the driving sensing electrodes 120 or all of the driving sensing electrodes 120 can be connected to one driving circuit 130 or a plurality of driving circuit 130 in a real design.

In the present embodiment, the driving circuit 130 includes a grounding unit 132 and a scanning unit 134. The scanning unit 134 includes a charge circuit C, a storage circuit P, and a read-out circuit R, wherein the charge circuit C and the storage circuit P are connected in parallel and the read-out circuit R is connected to the storage circuit P.

In addition, the driving circuit 130 is, for example, configured with four switches which are respectively a switch SW1, a switch SW2, a switch SW3, and a switch SW4. The switch SW1 is used for controlling whether or not to couple the charge circuit C, the storage circuit P, and the read-out circuit R in the scanning circuit 134 to the driving sensing electrode 120. Moreover, the switch SW2 is used for controlling whether or not to couple the charge circuit C to the switch SW1 and the switch SW3 is used for controlling whether or not to couple the storage circuit P and the read-out circuit R to the switch SW1 in the scanning unit 134. The switch SW4 is configured in the grounding unit 132 for controlling whether or not to connect the driving sensing electrode 120 to the ground.

In the present embodiment, a driving method of the surface capacitive touch panel 100 includes, for example, sequentially scanning the driving sensing electrodes 120 to receive a signal of the scanned driving sensing electrode 120. Herein, the so-called “sequentially scanning” means that the driving sensing electrodes 120 are conducted to the scanning unit 134 in batches or one by one. When one driving sensing electrode 120 is conducted to the scanning unit 134, other driving sensing electrodes 120 are conducted to the grounding unit 132. In addition, the scanning sequence of the driving sensing electrodes 120 in the invention is not restricted to be based on the spatial arrangement of the driving sensing electrodes 120. For example, the driving sensing electrodes 120 illustrated in FIG. 1 can be scanned from the left side to the right side, from the right side to the left side, an interval, every other one, every other two or more, or irregularly.

In detail, the driving sensing electrodes 120 of the surface capacitive touch panel 100 are sequentially an electrode X1, an electrode X2, an electrode X3, an electrode X4, an electrode X5, an electrode X6, an electrode X7, and an electrode X8. Under the design of the present embodiment, the electrode X3 is conducted to the scanning unit 134 through the conduction of the switch SW1 in the scanning unit 134 and the disconnection of the switch SW4 in the grounding unit 132. On the other hand, the electrode X3 is conducted to the grounding unit 132 through the conduction of the switch SW4 in the grounding unit 132 and the disconnection of the switch SW1 in the scanning unit 134. Herein, the grounding unit 132 is, for example, connected to a grounding voltage, a fixed voltage, or a high impedance element.

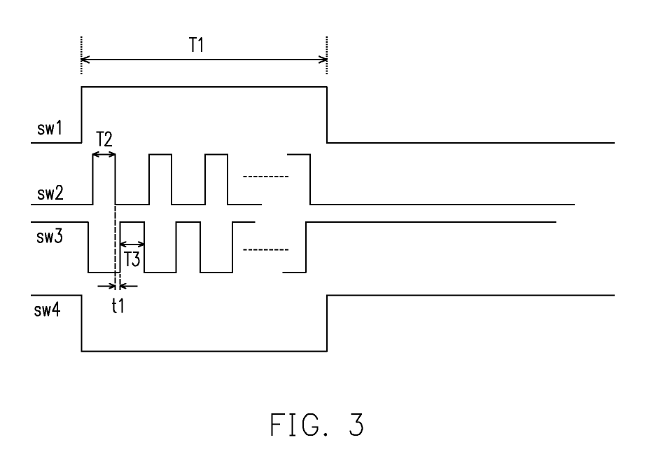

FIG. 3 schematically illustrates driving waveforms of the switches in the driving circuit during scanning period according to an embodiment of the invention. Referring to FIG. 3, the waveforms illustrated in FIG. 3 sequentially show the driving waveforms of the switch SW1, the switch SW2, the switch SW3, and the switch SW4 from top to bottom. Time T1 is the time period performing the scanning action. In the present embodiment, the high level in each waveform represents the conduction of the corresponding switch SW1˜SW4 (i.e. turn on) and the low level in each waveform represents the disconnection of the corresponding switch SW1˜SW4 (i.e. turn off).

Referring to FIG. 1 and FIG. 3 simultaneously, the switch SW1 is conducted and the switch SW4 is disconnected during time T1. Therefore, the corresponding driving sensing electrode 120 is conducted to the scanning unit 134 to be scanned and perform a sensing action. During time T1, the switch SW2 and the switch SW3 are alternately conducted and alternately disconnected. In the present embodiment, the conducting time periods of the switch SW2 and the switch SW3 are respectively time T2 and time T3, and the conduction of the switch SW3 is delayed for time t1 after time T2. Accordingly, during time T1, the corresponding driving sensing electrode 120 is connected to the charge circuit C and the storage circuit P alternately. In an embodiment, time T1 can be 20 μs, time T2 and time T3 are respectively 0.3 μs, and time t1 can be 0.025 μs, for example. However, according to different driving methods, time T3 can be closely next to time T2, i.e. time t1 can be zero second. In a word, the time periods can be decided to be longer or shorter based on the ability of the driving circuit 130 and the size design of a real product.

In the present embodiment, the charge circuit C is connected to a power (not illustrated) and the storage circuit P is connected to an external capacitor Cout, for example. When the surface capacitive touch panel 100 is touched by a finger of a user or a conductive material, a touch capacitance is formed between the conductive film 110 and the finger (or the conductive material). The touch capacitance is charged and discharged by the charge circuit C and the storage circuit P alternately. The read-out circuit R can read out the charge parameter of the touch capacitance, such as voltage which is served as a reference for determining the touch position, during time T1. In the present embodiment, the design mentioned above is merely one method for accomplishing the driving circuit 130. In other embodiments, the driving circuit 130 can be formed by other units. That is to say, any circuit design capable of connecting to the driving sensing electrode 120 to determine the generation of the touch capacitance can be applied in the layout of the driving circuit 130 of the invention.

Referring to FIG. 1 continuously, in a simulation test, it is assumed that a touch area of a touch action on the surface capacitive touch panel 100 is 5 mm×5 mm and the capacitance of the external capacitor Cout configured in the storage circuit P is, for example, 100 pf. In addition, nine touch positions are simulated in the simulation test and centers of the touch positions are positions I˜IX, wherein the positions I˜III are aligned to the electrode X4, the positions IV˜VI are shifted respectively from the positions I˜III toward the electrode X5 in the higher impedance direction H, and the positions VII˜IX are further shifted respectively from the positions IV˜VI toward the electrode X5 in the higher impedance direction H. In the simulation test, the distances from positions VII˜IX to the electrode X4 are configured to be equivalent to the distances from positions VII˜IX to the electrode X5, respectively.

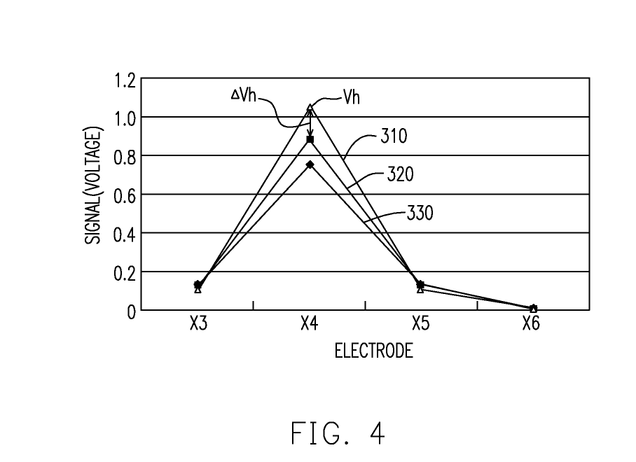

FIG. 4 to FIG. 6 schematically illustrate the signals received by the electrodes X3 to X6 in a simulation test. Referring to FIG. 1 and FIG. 4 together, the conductive film 110 in the present embodiment has the anisotropy of impedance so that the transmission path of the current is mainly parallel to the lower impedance direction D. When the position I is touched, the signals received by the electrodes X3˜X6 (such as the voltage read out by the read-out circuit R) are substantially shown in the line 310 of FIG. 4. When the positions II and III are touched, the signals received by the electrodes X3˜X6 are substantially shown in the lines 320 and 330 of FIG. 4.

Though the positions I˜III are aligned to electrode X4, different touch signals are generated, wherein the signal received by the electrode X4 is relative smallest when the position III is touched. Based on the simulation test, the closer the touch positions I˜IX to the driving sensing electrode 120 is, the larger the signal received by the driving sensing electrode 120 is. Accordingly, the surface capacitive touch panel 100 can determine the coordinate of the touch position in the lower impedance direction D based on the value of the signal received by the driving sensing electrodes 120.

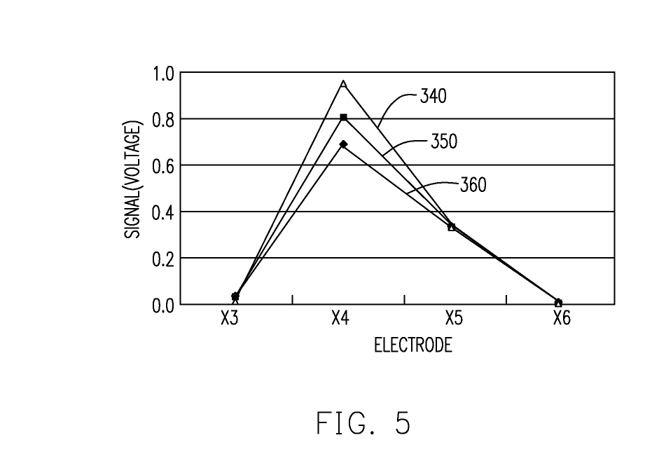

Next, referring to FIG. 5, the lines 340˜460 sequentially show the signals received by the electrodes X3 to X6 when the positions IV˜VI are touched. The positions IV˜VI are respectively shifted from the positions I˜III toward the electrode X5 in the higher impedance direction H so that the touch capacitance can be charged and discharged through both the electrode X4 and the electrode X5. Nevertheless, the signal received by the electrode X4 is higher than that received by the electrode X5 when the touch point is at one of the positions IV˜VI.

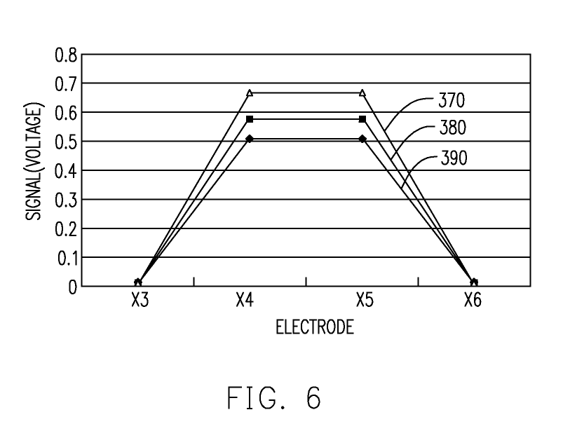

Similarly, referring to FIG. 6, the lines 370˜390 sequentially show the signals received by the electrodes X3 to X6 when the positions VII˜IX are touched. Herein, when one of the positions VII˜IX is touched, the signals received by the electrode X4 and the electrode X5 are substantially the same in value. Based on the relationships show in FIG. 4 to FIG. 6, the coordinated of the touch position in the higher impedance direction H can be determined through comparing the signals received by three adjacent driving sensing electrodes 120. For example, in order to determine the coordinate of the touch position in the higher impedance direction H, two higher values of the signals received by three adjacent driving sensing electrodes 120 are selected, and the corresponding coordinate is obtained by calculating the two higher values in a interpolation algorithm or in a proportional algorithm into a spatial position between the electrodes X4 and X5. The proportional algorithm described herein can be decided based on the change of the signals received in the simulation test.

Specifically, after completing the surface capacitive touch panel 100, relationships between the signals received by the driving sensing electrodes 120 and the touch positions can be obtained according to the required resolution in a simulation test. The relationships can be built in a driving sensing chip for determining the touch position when the surface capacitive touch panel 100 is really used.

The conductive film 110 of the present embodiment has the anisotropy of impedance so that the signals received by the driving sensing electrodes 120 are related to the distances from the touch position to the driving sensing electrodes 120. Therefore, the surface capacitive touch panel 100 has better sensing accuracy. In addition, the surface capacitance touch panel 100 can determine the touch position through directly reading the value of the signal received by the electrodes and comparing the values of the signals received by the adjacent electrodes, and thus a complex driving method and calculation program are not needed. As a whole, the surface capacitive touch panel 100 provided in the present embodiment has the characteristics of simple structure, high sensing accuracy, and easy driving method.

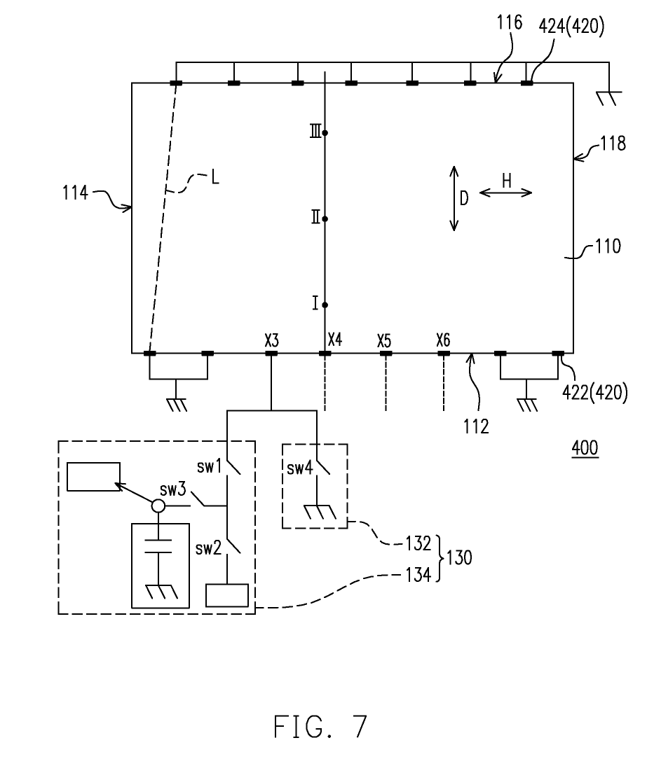

FIG. 7 illustrates a schematic view of a surface capacitive touch panel according to another embodiment of the invention. Referring to FIG. 7, a surface capacitive touch panel 400 includes a conductive film 110, a plurality of driving sensing electrodes 420, and a driving circuit 130. In the present embodiment, the conductive film 110 is the same as the conductive film depicted in the aforesaid embodiment, and the design of the driving circuit 130 is the same as that in the aforesaid embodiment. Therefore, the same or similar elements are marked in the same reference number in the drawings. The driving sensing electrodes 420 includes a plurality of first driving sensing electrodes 422 and a plurality of second driving sensing electrodes 424 in the present embodiment.

Particularly, the first driving sensing electrodes 422 and the second driving sensing electrodes 424 are respectively located at two opposite sides of the conductive film 110, that is, the side 112 and the side 116. The sizes and the pitches of the first driving sensing electrodes 422 and the second driving sensing electrodes 424 can be referred to the descriptions in the foregoing embodiment, but can be modulated according to the design of the real products and the application requirements. A straight line L connected from each first driving sensing electrode 422 to any second driving sensing electrode 424 is interlaced with and not parallel to the lower impedance direction D. Namely, the first driving sensing electrodes 422 and the second driving sensing electrodes 424 are alternately disposed in the higher impedance direction H.

A driving method of the surface capacitive touch panel 400 includes sequentially scanning the first driving sensing electrodes 422 and the second driving sensing electrodes 424 for performing the sensing action. When the first driving sensing electrodes 422 are sequentially scanned for performing the sensing action, the second driving sensing electrodes 424 are conducted to the grounding unit 132. Similarly, when the second driving sensing electrodes 424 are sequentially scanned for performing the sensing action, the first driving sensing electrodes 422 are conducted to the grounding unit 132. Accordingly, when the driving sensing electrodes 420 at the side 112, that is the first driving sensing electrodes 422, are scanned and perform the sensing action, the second driving sensing electrodes 424 at another side 116 of the conductive film 110 are connected to a grounding voltage, a fixed voltage, or a high impedance element. When the driving sensing electrodes 420 at the side 116, that is the second driving sensing electrodes 424, are scanned and perform the sensing action, another side 112 of the conductive film 110 is connected to a grounding voltage, a fixed low voltage, or a high impedance element.

Alternatively, a driving method of the surface capacitive touch panel 400 can include alternately scanning the first driving sensing electrodes 422 and the second driving sensing electrodes 424 for performing the sensing action. Herein, one first driving sensing electrode 422, one second driving sensing electrode 424, another first driving sensing electrode 422, and another second driving sensing electrode 424 . . . can be sequentially scanned. Namely, the electrodes at the two sides 112 and 116 are not scanned in a particular sequence for determining the coordinates of the touch positions.

Furthermore, the driving method of the surface capacitive touch panel 400 can be performed by merely scanning the driving sensing electrodes 420 at the side 112, i.e. the first driving sensing electrodes 422, for performing the sensing action. In the meantime, all of the second driving sensing electrodes 424 are steadily connected to the grounding voltage, the fixed voltage, or the high impedance element. On the other hand, the driving method can be performed by merely scanning the driving sensing electrodes 420 at the side 116, i.e. the second driving sensing electrodes 424, for performing the sensing action and all of the first driving sensing electrodes 422 are steadily connected to the grounding voltage, the fixed voltage, or the high impedance element.

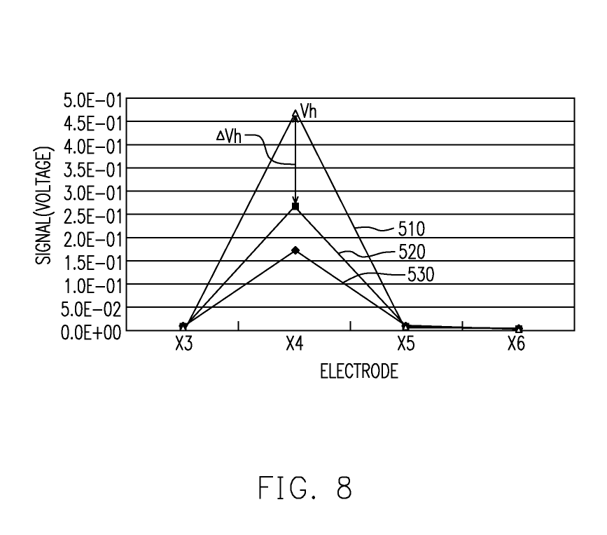

The design of the surface capacitive touch panel 400 is conducive to amplify the variance of the signals received by the driving sensing electrodes 420. For example, FIG. 8 schematically illustrates the signals received by the electrodes X3 to X6 of the surface capacitive touch panel 400 in a simulation test. Particularly, the lines 510˜530 illustrated in FIG. 8 represent the received signals of the surface capacitive touch panel 400 in FIG. 7 when the positions I˜III are touched. In addition to the disposition locations of the driving sensing electrodes 420, other parameters adopted in the simulation test of the present embodiment are the same as those adopted in the simulation test of the aforesaid embodiment and are not iterated herein. In other words, FIG. 8 and FIG. 4 respectively show the simulation results when the dispositions of the driving sensing electrodes are different. The scanning and driving methods depicted in the aforesaid embodiment can be adopted in the simulation test of the present embodiment. Namely, the scanning sequence of the driving sensing electrodes 420 is not specifically restricted and it is possible to merely scan a portion of the driving sensing electrodes 420.

In the signals generated when the positions I˜III are touched, a ratio of the variance Vh of high signals to the maximum Vh of high signals is positively proportional to the variance of signals. Generally, the enlargement in the variance of signals is conducive to divide the signal range into more intervals. That is to say, though the shift distance of the touch positions is reduced, the surface capacitive touch panel 400 can still effectively adjust the accurate touch position to be conducive to enhance the positioning resolution. Therefore, according to the results shown in FIG. 4 and FIG. 8, the simulation test in FIG. 8 can provide a larger variance of signals so as to have higher positioning resolution under the same simulation parameters. In other words, the surface capacitive touch panel 400 can adjust more touch points than the surface capacitive touch panel 100 when the size of the panels is the same. Accordingly, the surface capacitive touch panel 400 is conducive to further improve the positioning resolution merely through changing the dispositions of the driving sensing electrodes 420.

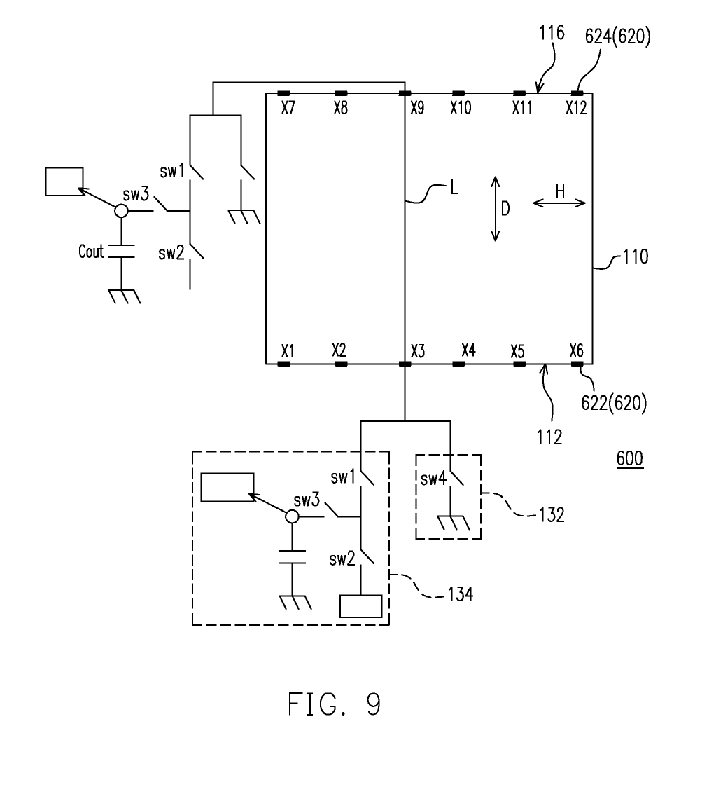

FIG. 9 illustrates a schematic view of a surface capacitive touch panel according to further another embodiment of the invention. Referring to FIG. 9, the surface capacitive touch panel 600 is similar to the surface capacitive touch panel 400, wherein the same elements are marked by the same reference numbers. The difference between the surface capacitive touch panel 600 and the surface capacitive touch panel 400 lies in that the driving sensing electrodes 620 are disposed right opposite to one another. That is to say, the driving sensing electrodes 620 includes a plurality of first driving sensing electrodes 622 disposed at the side 112 and a plurality of second driving sensing electrodes 624 disposed at the side 116. A straight line L connected from each first driving sensing electrode 622 to one second driving sensing electrode 624 is parallel to the lower impedance direction D. Specifically, a straight line L connected from each first driving sensing electrode 622 to the most adjacent one of the second driving sensing electrodes 624 is parallel to the lower impedance direction D.

It is noted that a driving method of the surface capacitive touch panel 600 includes, for example, simultaneously scanning one of the first driving sensing electrodes 622 and the corresponding second driving sensing electrode 624 opposite thereto for performing the sensing action. Namely, when the driving sensing electrodes 620 are arranged in the sequence of electrodes X1˜X12 illustrated in FIG. 9, the electrode X1 and the electrode X7 are simultaneously connected to the scanning unit 134 for performing the scanning and sensing action and other driving sensing electrodes 620 are connected to the grounding unit 132. Similarly, the electrode X2 and the electrode X8 are grouped as a pair, the electrode X3 and the electrode X9 are grouped as a pair, the electrode X4 and the electrode X10 are grouped as a pair, the electrode X5 and the electrode X11 are grouped as a pair, and the electrode X6 and the electrode X12 are grouped as a pair. The electrodes grouped as a pair can be simultaneously scanned for performing a sensing action. Nevertheless, in other embodiment, two or more electrodes of the electrodes X1˜X6 (or X7˜X12) located at the same side can be simultaneously scanned for performing the sensing action.

When the driving sensing electrodes 620 grouped as a pair are scanned for performing the sensing action, the position of the touch capacitance generated by the touch action in the lower impedance direction D can be simultaneously determined according to the signals received by a pair of the driving sensing electrodes 620. Therefore, the accuracy of the touch position, and particularly, the coordinate in the lower impedance direction D can be further enhanced. Specifically, the paired electrodes (such as the electrode X1 and the electrode X7) can be synchronously or non-synchronously scanned.

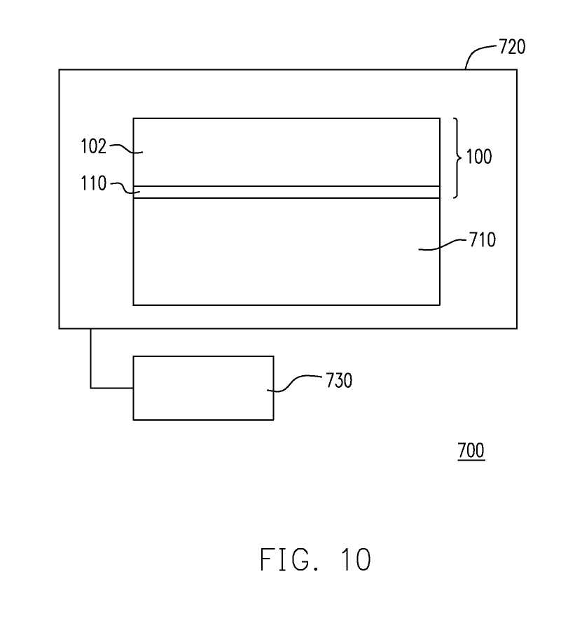

The surface capacitive touch panel according to the aforesaid embodiments can be applied in many optoelectronic devices or electronic apparatus. For example, referring to FIG. 10, the above surface capacitive touch panel 100 can be assembled with a display panel 710 to form a display apparatus 720. The surface capacitive touch panel 100 can be served as an element of the display apparatus 720 for providing a touch sensing function, wherein the display panel 710 can be disposed at any side of the substrate 102. That is to say, the conductive film 110 of the surface capacitive touch panel 100 can be disposed between the substrate 102 and the display panel 710. Certainly, the display panel 710 can be disposed at a side of the substrate 102 of the surface capacitive touch panel 100 away from the conductive film 110 (not illustrated in the drawing figure). For example, the conductive film 110 of the surface capacitive touch panel 100 can be disposed under the substrate 102 as shown in FIG. 10 so that the display panel 710 is disposed at a side of the substrate 102 adjacent to the conductive film 110. It is also possible to configure the conductive film 110 above the substrate 102 as shown in FIG. 2 so that the display panel 710 is disposed at a side of the substrate 102 away from the conductive film 110 (the display panel 710 is not shown in FIG. 2).

Furthermore, the display apparatus 720 having the combination of the above surface capacitive touch panel 110 and the display panel 710 can be configured with an input unit 730 to form an electronic apparatus 700. In the electronic apparatus 700, the input unit 730 is coupled to the display apparatus 720 and provides an input function to the display apparatus 720 so that the display apparatus 720 can display a required image. The input unit 730 can be a power button, a hotkey, or the like, which is capable of changing the current displayed image of the electronic apparatus 700. In addition, the electronic apparatus 700 can be a mobile phone, a digital camera, a personal assistant, a notebook, a desk-top computer, a television, a display in automobiles, or a portable DVD player.

In summary, a material having an anisotropy of impedance is used to fabricate the conductive film of the touch panel in the invention. The current in the touch panel is transmitted in a preferred direction, which can be served as a reference for determining the touch position. Therefore, merely a single conductive film can accomplish the 2-dimensional positioning determination in the invention. In addition, based on the characteristic of the conductive film, the positioning accuracy of the touch panel according to the invention is superior to that of the conventional surface capacitive touch panel. Furthermore, the resolution or the positioning accuracy of the touch panel can be enhanced through changing the disposition location of the electrodes according to different requirements.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A surface capacitive touch panel, comprising:
a substrate;
a conductive film formed on the substrate having an anisotropy of impedance to define a lower impedance direction and a higher impedance direction; and
a plurality of driving sensing electrodes disposed on at least one side of the conductive film and the at least one side being substantially perpendicular to the lower impedance direction.

2. The surface capacitive touch panel according to claim 1, wherein a length of each of the driving sensing electrodes along the higher impedance direction is from 1 mm to 5 mm.

3. The surface capacitive touch panel according to claim 1, wherein a pitch of the driving sensing electrodes is from 3 mm to 5 mm.

4. The surface capacitive touch panel according to claim 1, wherein the conductive film comprises a carbon nanotube film.

5. The surface capacitive touch panel according to claim 1, wherein the driving sensing electrodes comprises a plurality of first driving sensing electrodes and a plurality of second driving sensing electrodes, and the first driving sensing electrodes and the second driving sensing electrodes are respectively located at two opposite sides of the conductive film.

6. The surface capacitive touch panel according to claim 5, wherein a straight line connected from each of the first driving sensing electrodes to any of the second driving sensing electrodes is substantially interlaced with the lower impedance direction.

7. The surface capacitive touch panel according to claim 5, wherein a straight line connected from each of the first driving sensing electrodes to a most adjacent one of the second driving sensing electrodes is substantially parallel to the lower impedance direction.

8. The surface capacitive touch panel according to claim 7, wherein each of the first driving sensing electrodes and the most adjacent one of the second driving sensing electrodes are scanned simultaneously.

9. The surface capacitive touch panel according to claim 1, further comprising a driving circuit connected to at least one portion of the driving sensing electrodes to sequentially scan the at least one portion of the driving sensing electrodes.

10. The surface capacitive touch panel according to claim 9, wherein the driving circuit comprises a grounding unit and a scanning unit, each of the scanned driving sensing electrodes is connected to the scanning unit, and the un-scanned driving sensing electrodes are connected to the grounding unit.

11. The surface capacitive touch panel according to claim 10, wherein the scanning unit comprises a charge circuit, a storage circuit, and a read-out circuit, the charge circuit and the storage circuit are connected in parallel, and the read-out circuit is connected to the storage circuit.

12. A driving method for driving the surface capacitive touch panel according to claim 1, the driving method comprising:
sequentially scanning at least one portion of the driving sending electrodes; and
receiving the signals of the scanned driving sensing electrodes.

13. The driving method according to claim 12, further comprising comparing the signals of three adjacent driving sensing electrodes to calculate a position of a touch point in a direction perpendicular to the lower impedance direction.

14. The driving method according to claim 12, further comprising determining a position of a touch point in the lower impedance direction according to values of the signals of the driving sensing electrodes.

15. An electronic apparatus, comprising a display apparatus, the display apparatus comprising:
a surface capacitive touch panel and a display panel, the surface capacitive touch panel comprising:
a substrate, the display panel configured at a side of the substrate;
a conductive film formed on the substrate having an anisotropy of impedance to define a lower impedance direction and a higher impedance direction; and
a plurality of driving sensing electrodes disposed on at least one side of the conductive film and the at least one side being substantially perpendicular to the lower impedance direction.

16. The electronic apparatus according to claim 15, further comprising an input unit coupled to the display apparatus and providing an input function to the display apparatus so that the display apparatus displays an image.

17. The electronic apparatus according to claim 16, wherein the electronic apparatus comprises a mobile phone, a digital camera, a personal digital assistant, a notebook, a desk-top computer, a television, a display in automobiles, or a portable DVD player.
